(19) United States
(12) Patent Application Publication
(10) Pub. No.: US 2016/0216947 A1
(43) Pub. Date: Jul. 28, 2016

(54) Unifying Cloud Platform for Interconnected Applications

(71) Applicants: Arash Hassibi, Menlo Park, CA (US); Chris Brittain Dillar, Mountain View, CA (US)

(72) Inventors: Arash Hassibi, Menlo Park, CA (US); Chris Brittain Dillar, Mountain View, CA (US)

(21) Appl. No.: 15/006,042

(22) Filed: Jan. 25, 2016

Related U.S. Application Data
(60) Provisional application No. 62/107,676, filed on Jan. 26, 2015.

(51) Int. Cl. G06F 9/44; G06F 3/0484; G06F 3/0482; H04L 12/58

(52) U.S. Cl. CPC G06F 8/34; H04L 51/046; G06F 8/71; G06F 3/04842; G06F 3/0482

(57) ABSTRACT

Real-time messaging is a very familiar activity for users. Messaging apps allow users to create messaging channels through which users can message each other. Some of these channels are direct messaging channels between two users while others are group messaging channels connecting multiple users. For group messaging, users are able to bring in other users to the group via a user-interface for adding users. This invention describes how this user-interface can be easily extended to include interconnection with other data channels to create ingoing and outgoing message flows to other applications and services. This allows users to mashup content, message across platforms, share Internet of Things devices, and chain services all within the convenience of their messaging app.

Also in this invention it is described how the same user-interface can be used to add virtual user-workers or bots to group messages, allowing users to convert message channels to their own task-performing services for a variety of applications such as geo-notification, anti-spam, and language processing. In summary this invention outlines a framework for ‘do-it-all’ messaging apps that is based on overloading the same widget (control element) for adding members to a channel (e.g., the ‘+’ or ‘add user’ button) with the ability to include channel feeds and bots to that channel.

### BACKGROUND

The Internet has become increasingly mobile leading to significant growth in connected users and mobile applications. For example, the App Store as of today has 1.2M available apps. On the other hand, more and more things are being integrated with phones or getting directly connected to the web, such as GPS devices, health and activity trackers, home appliances and security systems, cars, and watches.

In this Internet of Systems ecosystem, while applications and things are connected to the web, they themselves are not directly connected to each other. This is a problem, and often to provide higher value to users content from various applications and things need to be recombined, or output from one needs to become a control input to another. Today this is not an easy task to accomplish by the average consumer, and connecting applications to each other requires building a new application which is an expensive and laborious process requiring software expertise. As a result of this, the Internet of Systems lacks communities and network effects, and the mobile internet landscape remains very fragmented and non-ubiquitous.

### SUMMARY

This invention describes a cloud-based platform for consumers to create new applications that enable recombining of content and services from other applications, including applications that are built on this platform. It also enables users to share with other users content and services across applications and from applications they own.

In one embodiment of this platform, businesses, community organizers, academic institutions, entertainers, celebrities, or other entities will be able to easily create mobile apps that serve the needs of those entities and drive user engagement in the community they represent. This is a Godaddy like platform tailored for creating mobile apps that have the ability to work for you in the background instead of creating websites that mostly serve as landing pages. Said another way, this embodiment represents a framework to create “mashup” applications enabling users to combine functionality from other applications to create bigger value apps to address user needs. For example a restaurant will be able to create an app that provides content from its Facebook page, shows the food delivery car in real-time on a map to customers, and send special offers to users who are in the vicinity of the establishment.

In another embodiment of this platform, users will not only be able to chat, create groups, and make friends with other users, but also be able to share content and services from their apps and things with those users. This embodiment represents a social network of the Internet of Things, which will enable users, applications, and things to connect easily with each other. This represents a “do-it-all” chat app for users to integrate apps and other functionalities inside their private instant messaging sessions with other users. For example a user will be able to share his Fitbit activity tracker device feed inside a chat with another user. Facebook helped connect users with other users while this embodiment helps connect users, applications, and things with other users, applications, and things.

In another embodiment of this platform, users will be able to chat across applications so for example a user on a messaging platform like Facebook Messenger will be able to chat with a user on another messaging platform like WeChat. This embodiment provides a roaming service across messaging services by implementing a Public Switched Messaging Network where user messages are automatically routed to the right application and user destinations. The telecommunications equivalent of this is how users are able to call other users across carriers through Public Switched Telephone Networks (PSTNs). For example users can easily call someone on Verizon from AT&T.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1a illustrates a user interface for a data hub or Public Switched Messaging Network in an embodiment of the system.

FIG. 1b illustrates the flow of data among interconnected applications in an embodiment of the system.

FIG. 1c illustrates a user interface for using applications as building block functions in an embodiment of the system.

FIG. 1d illustrates the concept of using multiple profiles an embodiment of the system.

FIG. 2a illustrates a user interface for adding components to build a new application in an embodiment of the system.

FIG. 2b illustrates the concept of the equivalence of new networked applications and the component building blocks in an embodiment of the system.

FIG. 3 illustrates a user interface for adding feed-ins, feed-outs, and virtual workers (or chat bots) to build a new application in an embodiment of the system.

FIG. 4a illustrates a user interface for adding users to a channel to build a new application in an embodiment of the system.

FIG. 4b illustrates a user interface for adding channel feed-ins and feed-outs to build a new application in an embodiment of the system.

FIG. 4c illustrates a user interface for adding virtual workers (or chat bots) to build a new application in an embodiment of the system.

FIG. 5a illustrates an example of a channel in a feed view in an embodiment of the system.

FIG. 5b illustrates an example of a channel in an album view in an embodiment of the system.

FIG. 5c illustrates an example of a channel in a map view in an embodiment of the system.

FIG. 5d illustrates an example of a channel in a calendar view in an embodiment of the system.

FIG. 6a illustrates the flow of new application creation in an embodiment of the system.

FIG. 7a illustrates the flow of mashup application creation in an embodiment of the system.

FIG. 7b illustrates an example of a new mashup application created in an embodiment of the system.

FIG. 7c illustrates an example of a new application created using a template in an embodiment of the system.

FIG. 8 illustrates possible components for combining into an application in an embodiment of the system.

FIG. 9 illustrates a user interface for combining components to create a mashup application in an embodiment of the system.

FIG. 10a illustrates an example of an application built using an embodiment of the system.

FIG. 10b illustrates a user interface for building a web application in an embodiment of the system.

### DETAILED DESCRIPTION

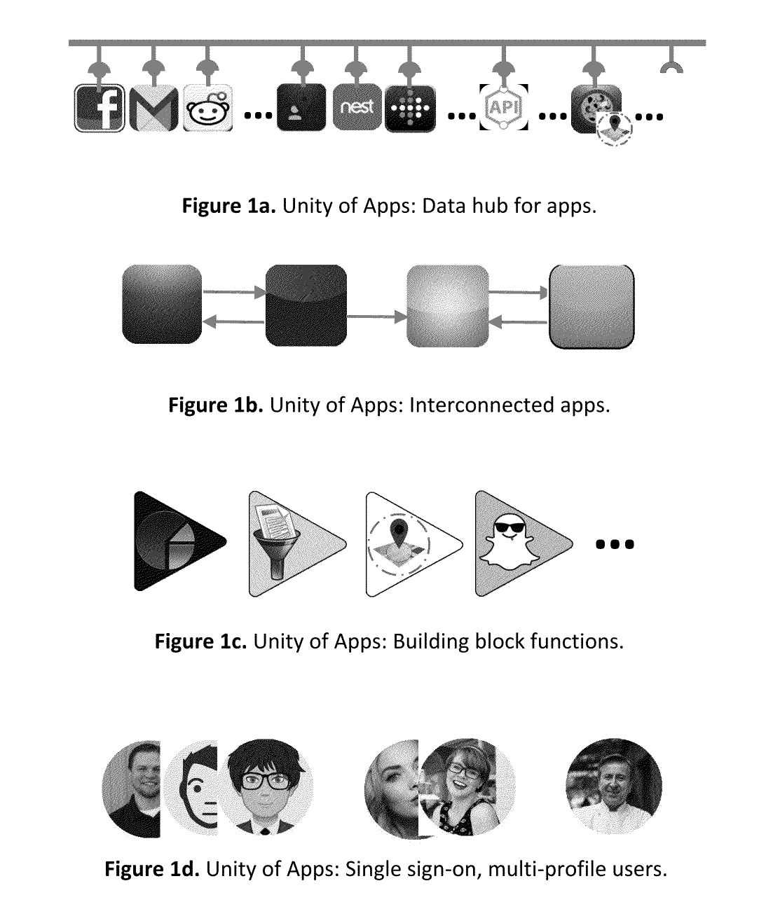

The platform described in this invention defines a Unity of Apps solution with the following technology principles (FIGS 1a-d):

1. Data hub or Public Switched Messaging Network for apps. All apps and things are easily pluggable to a common data hub or public switched messaging network. This is what provides system integration with user apps and things. Users are able to authenticate applications and things to privately and securely connect to the system, and then engage them transparently as data sources or provide access control to them to other users. For example this allows users to push content of their Facebook page to an app, share their location feed as a delivery driver, give a neighbor access to smart home controls while on vacation, or enable others to save content to a Dropbox folder.

2. Interconnected apps. All apps created in this ecosystem as well as those plugged in to the data hub can talk to each other. In other words, content of any app can be routed to any other app, or provide command signals to that app to do something or utilize a service. For example a user can build an application that controls the Philips Hue lamp system of a friend.

3. Building block functions. Building blocks of functionality are provided as cloud services for reuse in apps, and new ones can be easily added by the community. Examples include user analytics content providers, semantic filters for antispam, geofencers and various other location based functions, and content snappers that auto delete specific content after a predetermined time.

4. Single sign-on, multi-profile users. While users sign-on to the system with a single set of credentials, users are able to create different profiles for different apps. This is very different from Facebook for example, where users only have one alias or identity. In a diverse app ecosystem users expect compartmentalization so that in some apps they can engage with a more public profile while in others they can be more anonymous. Other users cannot tell whether or not two different profiles belong to the same user.

Converting Chats to Apps

Real-time mobile chat is a very familiar activity for users and the apps created through this platform build upon chats. This section describes how on this platform a chat session can be easily converted to an app that does something useful in the background for the user.

Messaging apps generally allow users to create various groups or channels in which users can message each other. Some of these channels are direct message channels to other users while others are group chat channels in which multiple users engage in.

Apps created in this Unity of Apps platform are similar to such messaging apps in that they are also multi-channel apps, with each channel being a sequence of message posts. These channels can be of type:
Public. All users of the app are able to view messages posted to the channel. Users may or may not have permission to post messages to such a channel.
Private. A subset of users of the app are able to view messages posted to the channel. Private chat message channels fall into this category for which two or more users message each other. It is also possible for a private channel to only have one user when for example a user creates a channel to aggregate content from multiple channels into one for ease of viewing.
Invisible. Users of the app cannot view such channels. The purpose of an invisible channel is to intermediately combine data from different content sources to do something or provide a result that will eventually be routed to a visible channel.

Channels in the Unity of Apps platform can be set as input or output to other channels as continuous real-time feeds if users have appropriate permission to those channels. This is how apps get to talk to each other and become interconnected. Each channel can have:
Feed-ins. These are input channels that provide content to the channel.

Any message posted to a feed-in channel is instantaneously routed to the channel. You can think of the input channel as a channel that is being followed to use terminology from apps such as Twitter, Tumblr, and Pinterest.
Feed-outs. These are output channels that follow content of the channel. Any message posted or data routed to the channel will instantaneously be routed to the feed-out channels.

In addition to users, feed-ins and feed-outs, channels can also have virtual user-workers assigned to them. If feed-ins and feed-outs provide integration with other apps and things, these virtual user-workers provide the intelligence, and are the building block functions described in the Unity of Apps framework. For example, you can add a worker that filters spam, posts geofence updates of a user, or sends an alert when a front door opens. In one embodiment of this that applies to messaging, these workers are called chat bots.

The ability to add channel feeds and workers to a channel is what makes the app really an app, and be able to perform useful tasks in real-time and in the background.

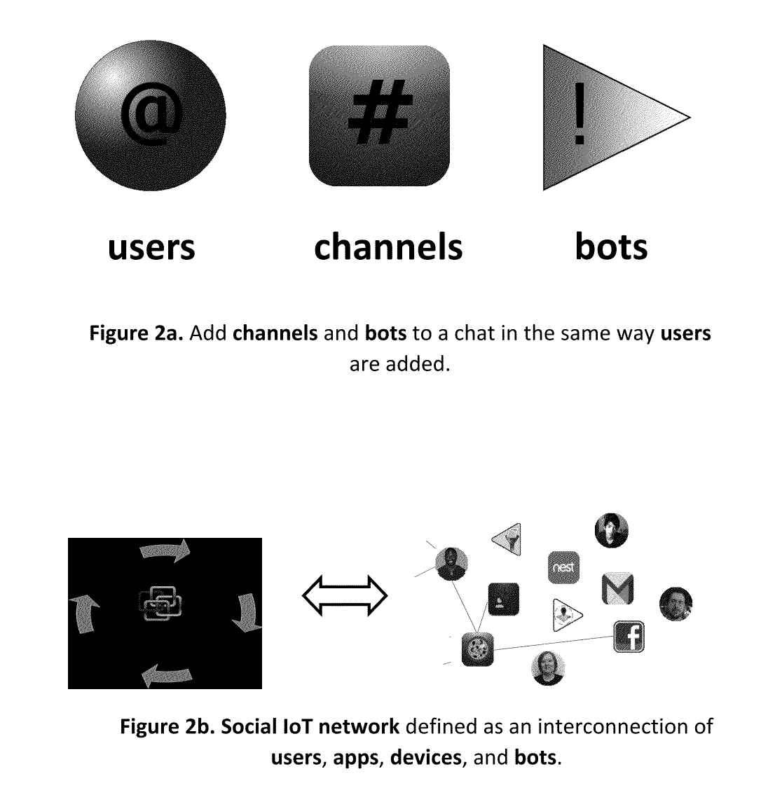

FIG. 2 shows this “Chat to App” design principle. In the same user familiar fashion of adding members to channels, users can add feed-ins, feed-outs, and virtual workers (or chat bots) to create application specific functionality and smart channels.

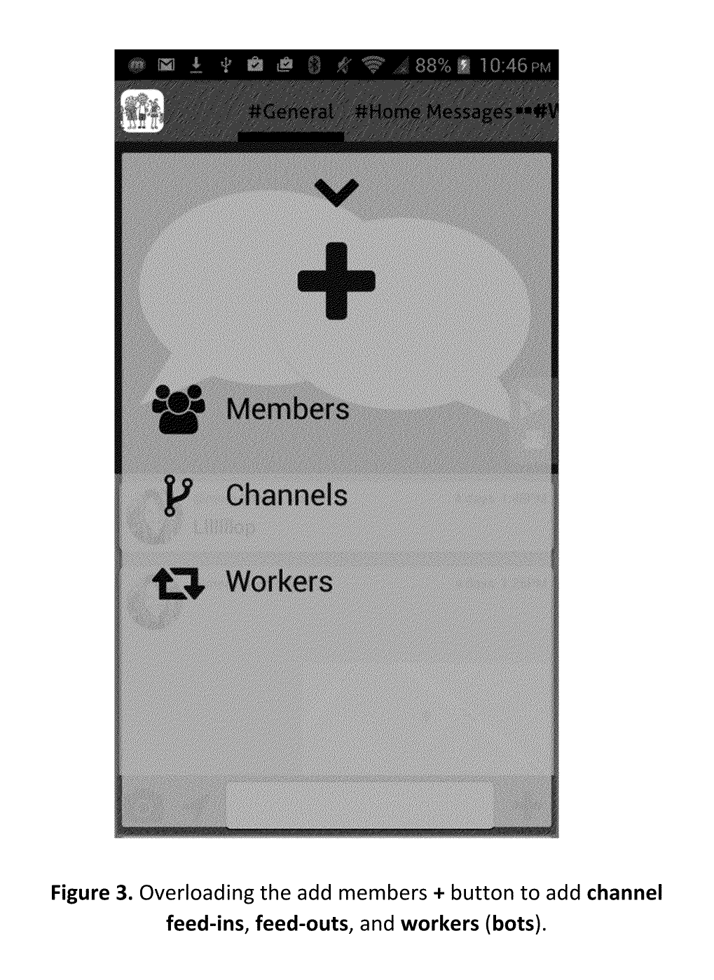

In one embodiment, the user interface to the app overloads the same widget (control element) for adding members to a channel (e.g., the ‘+’ or ‘add user’ button) so that it can also be used to add feed-ins, feed-outs, and virtual workers (or chat bots) to a channel (FIG. 3). This provides an intuitive and familiar user flow to convert chats to apps.

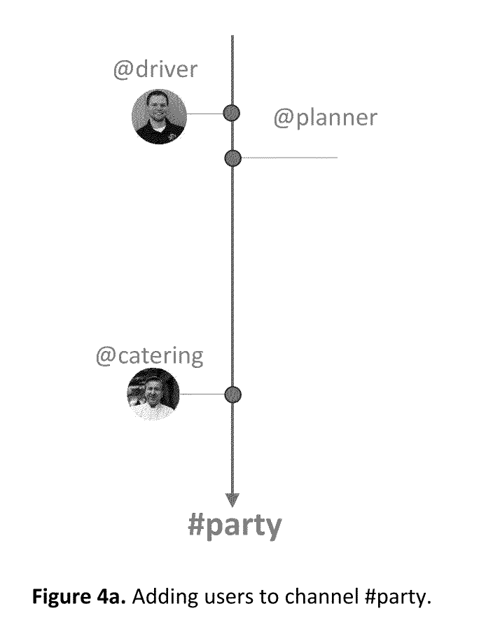

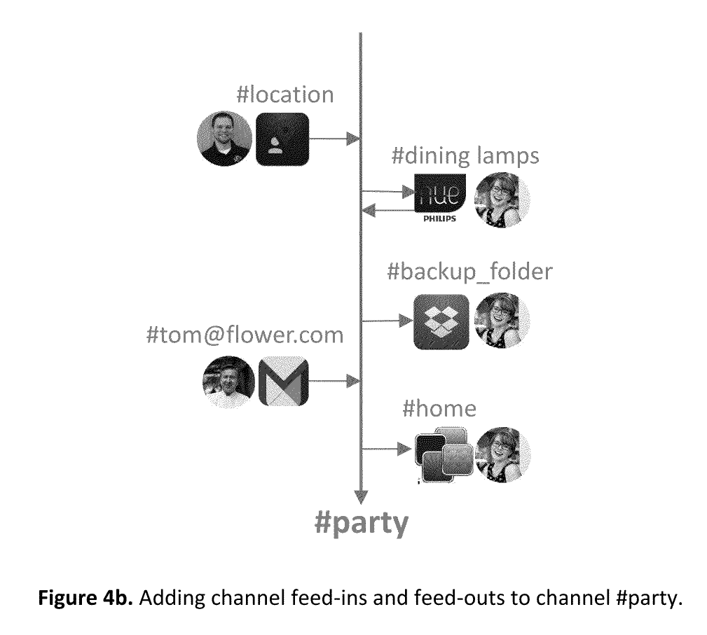

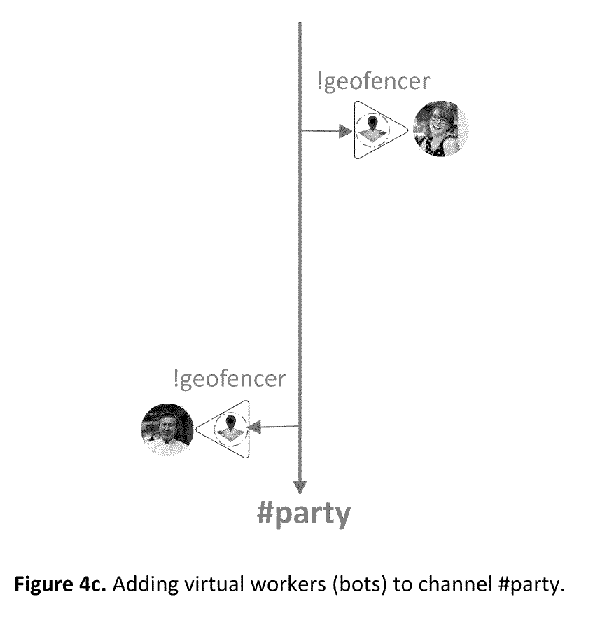

FIG. 4 provides an example of how this can be done. Let's say a party is being organized and the user @planner creates a channel #party to coordinate the tasks. She then adds two other members to the channel: users @driver and @caterer (FIG. 4a). This is done in the user interface through a widget for adding members to a channel.

Now using the same widget for adding members, users add channel feeds (FIG. 4b). @driver provides his #location coming from his GPS enabled phone as a feed-in to #party. @driver as a user of the platform will have his location feed routed through the data hub and available to share transparently in the way we just described. This will allow @caterer and @planner to know when the driver is near or far from their locations of interest and coordinate accordingly. @planner sets #dining lamps from her Philips Hue app as both feed-in and feed-out, so that @driver and @caterer are now able to control and see the lamps' state by posting on, off, flash, etc. messages to #party. @planner also adds her Dropbox folder #backup_folder as a feed-out so content on #party gets automatically saved to that Dropbox folder. She also adds #home from another application as feed-out so she can see the contents of #party in #home (where she perhaps aggregates all her important content for viewing). @caterer adds emails he receives from tom@flower.com as a feed-in, so that important emails from the flower shop appear in real-time for everyone on the channel to view.

Finally, using the same widget for adding members, users are able to add virtual workers (FIG. 4c). @planner and @caterer add !geofencer workers on the #location of @driver so they get notified whether or not @driver is near them when they expect him to be.

Creating Mashup Applications

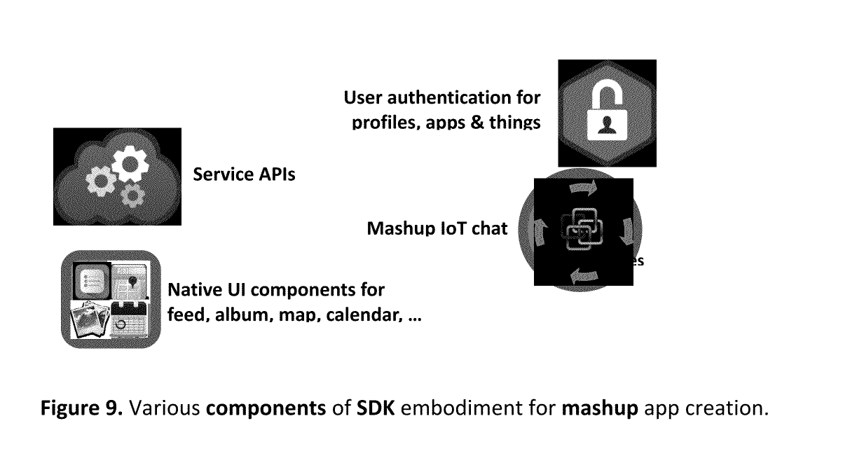

It is possible to easily create very sophisticated mashup apps by connecting apps, things, API services, and virtual workers (bots) in this framework. In one embodiment of this a Software Development Kit (SDK) and/or Integrated Development Environment (IDE) will be provided for app developers. This simplifies the app development process by enabling developers to focus on creating functionality by defining interconnections of existing building blocks (apps, APIs, things, bots) through an easy drag-and-drop process instead of dealing with the nitty gritty details of programming. FIG. 9 shows various components of such an SDK:

1. User authentication for profiles, apps & things (e.g., user's LinkedIn profile, Facebook app, or Fitbit device),

2. Various cloud service APIs (e.g., geofencing, antispam, payment, and SMS),

3. Mashup Internet of Things messaging (or ‘do-it-all’ chat that unifies instant messaging with the ability to share, connect, or consolidate content and services from other apps, devices, and APIs).

4. Native UI components for feed, album, map, calendar, . . . (these are optimized for great user experience).

Here is a list of app segments that can benefit from using this mashup app technology:
Health/activity (consolidate and share activity from devices, messaging, ghost racing on map).
Home automation (control all smart appliances from one app, give access control to neighbor when on vacation).
News (create mashup of news from various sources).
Businesses (messaging and message boards for employees, geo-offers and check-in coupons for clients, push to all social channels from one place, payment integration, guest book or at location reviews).
Social/groups (compartmentalized group around a shared interest or place like a church, student club, hotel, night club, or tradeshow).
Productivity (consolidate email, social, news, etc. all in one app for user).
Finance (consolidate financial news and integrate various financial APIs such as: http://www.programmableweb.com/news/25-finance-apis/2008/04/24).
Medical (integration of health trackers, real-time emergency notification using NFC tags).
Travel (location sharing, consolidated social feeds of places including Facebook and Yelp, Google translate integration, at location reviews).
Family (various geo-notifications for safety, location/battery/activity sharing, ability to share email/SMS messages, monitor health of elderly person through sharing cell phone screen lock/unlock or usage).
Event (integration with Google calendar and Gmail, guest book and check-in functionality, consolidated social feeds).

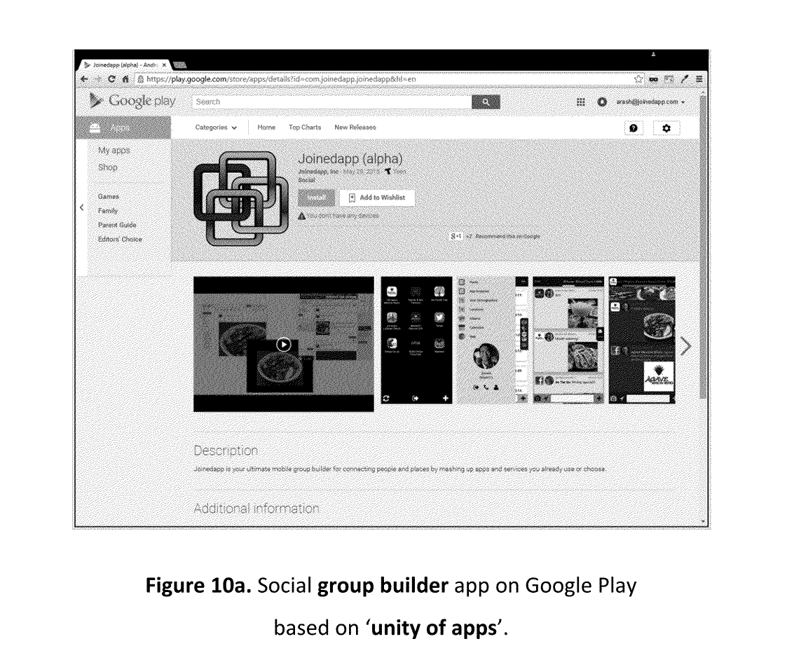

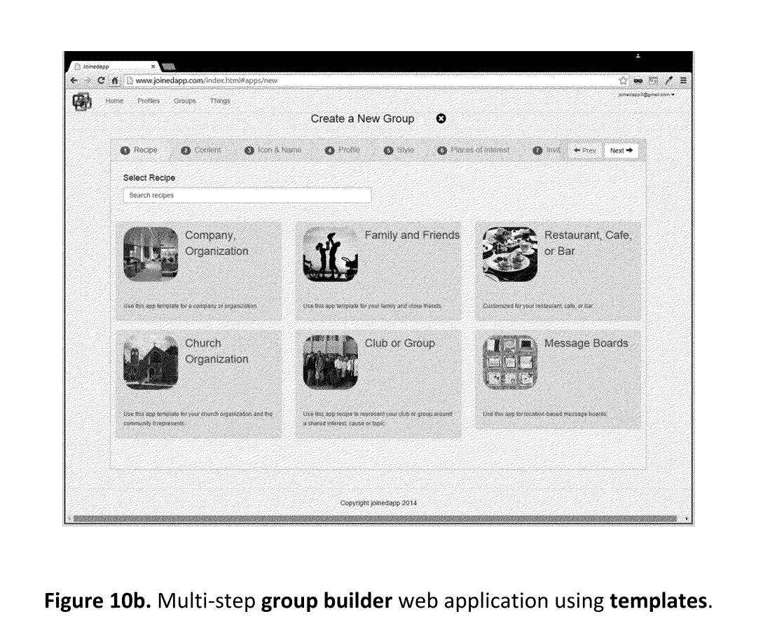

In another embodiment of this, a social group builder app can be developed that gives group organizers and users the ability to mashup and share the apps and services they already use or choose. FIG. 10a shows the alpha version of such a product on Google Play. FIG. 10b shows a web application to create such integrated groups in a multi-step process.

Channel Views

As mentioned earlier apps created using this platform consist of channels which define a sequence of messages posts. These posts can be sent by users, virtual user-workers (aka chat bots), or other applications and things through channel feed-ins. That being said, channels can have different views and render posts differently. These views include:
Feed. Posts are displayed as messages in a card view linear layout, similar to chat and messaging apps.
Album. Posts are displayed based on their media attachment in a Polaroid image staggered layout, similar to the Pinterest layout.
Map. Posts are displayed based on their geo coordinates as pin drops on a map. A location feed is displayed by its (fading) trajectory resembling a moving target.
Calendar. Posts are displayed based on their event data on a calendar.
Web. Posts are displayed based on their URL data in a web browser.
Game. Posts are displayed by their j script content in Cocos2D.
Survey/Quiz. Posts are displayed as survey/quiz questions based on their content to collect user responses.

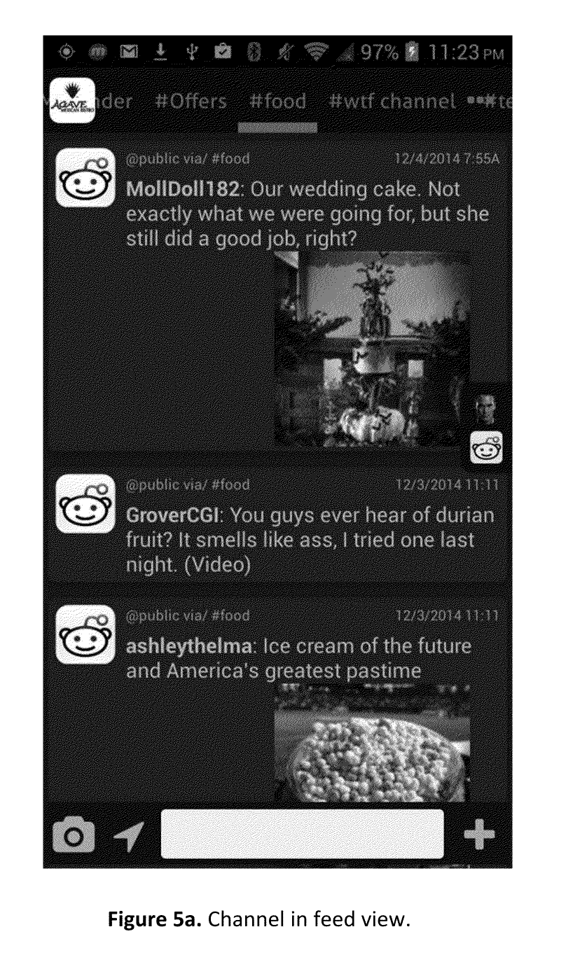

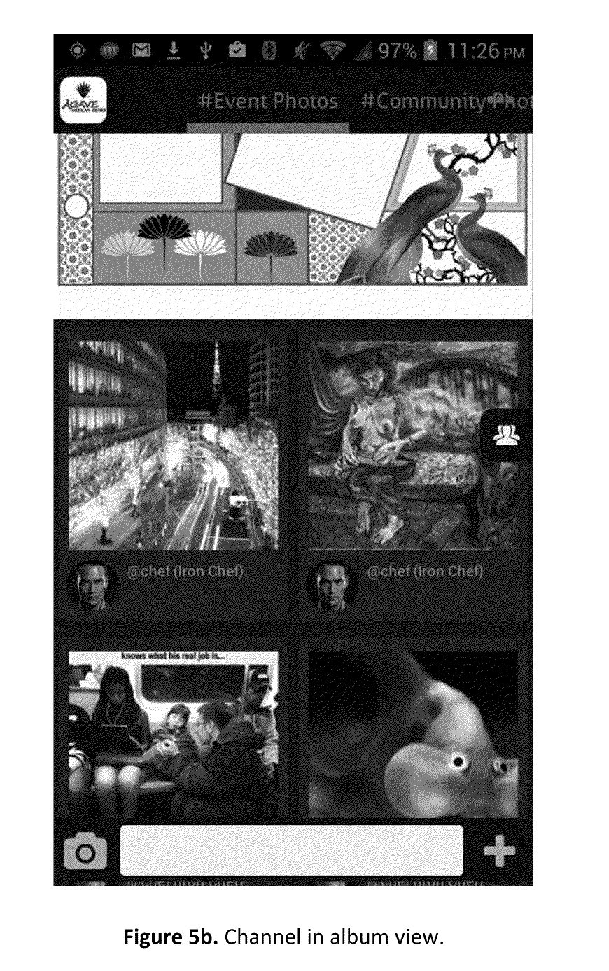

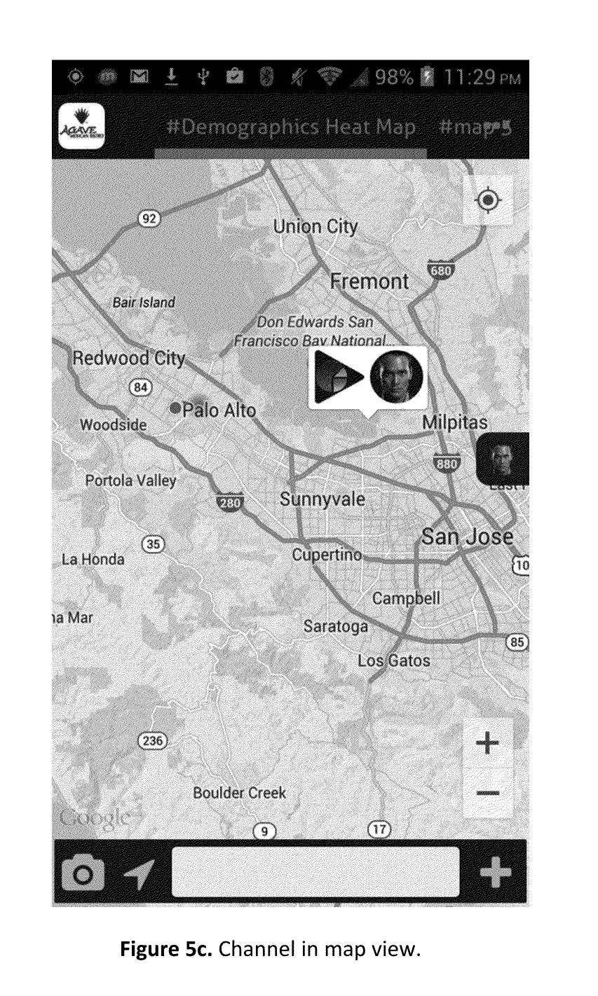

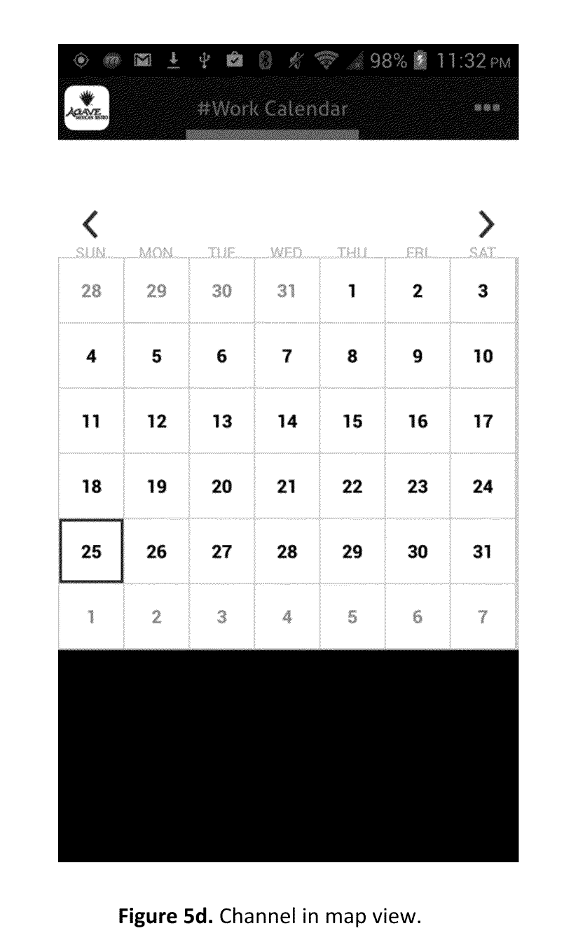

See FIGS. 5a-d for how these views appear in one embodiment.

App Templates

Push button app creation using this platform is enabled through app templates or recipes. App templates are available for different verticals or segments (restaurant, church, company, club, family, etc.) and come with preset channels of defined type (public, private, or invisible), view (feed, map, album, etc.), interconnection (feed-ins and feed-outs), and virtual workers. As a result, when a user creates an app using an existing template the result will be an out-of-the-box sophisticated app without the need to for the user to have to manually create and connect channels, and drop the right set of virtual workers into them.

For example an app template for a small business can have a public channel called #Home with the app creator's Facebook page and Twitter feed set as feed-in and feed-out, and an anti-spam virtual user-worker set as member. This means that any post from a mobile app user that passes the anti-spam test will appear on #Home and automatically be routed to Facebook and Twitter due to the feed-outs. On the other hand, any post to Facebook and Twitter that passes the anti-spam test will appear on #Home due to the feed-ins.

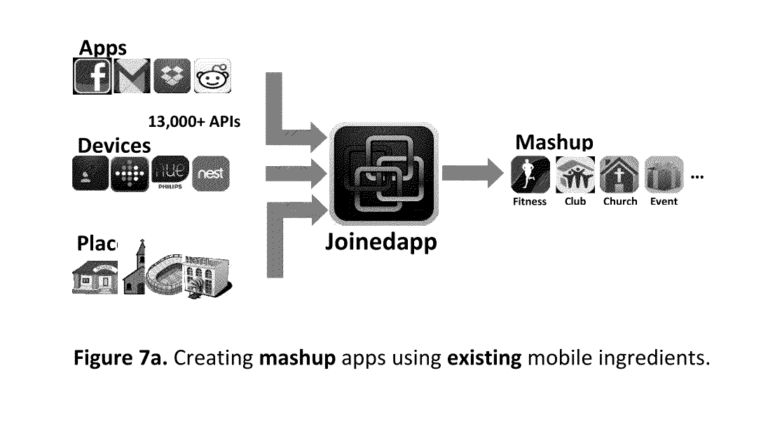

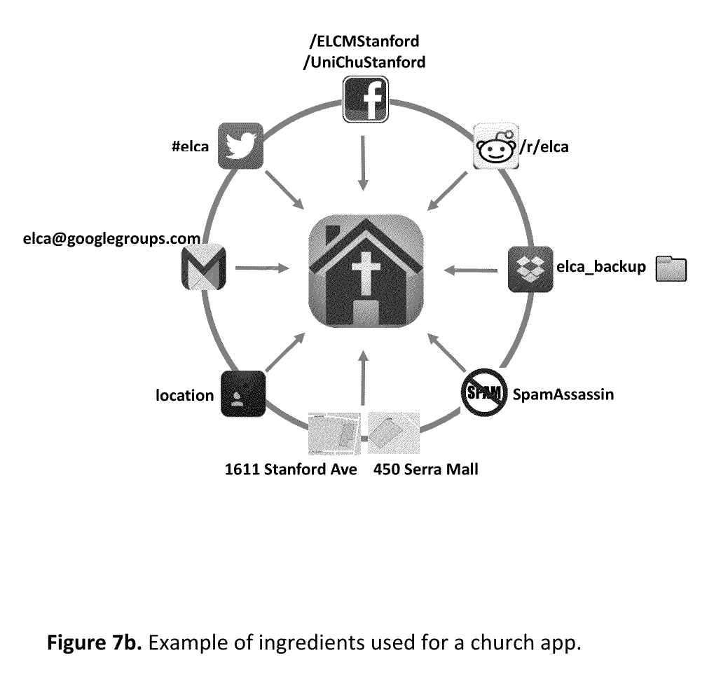

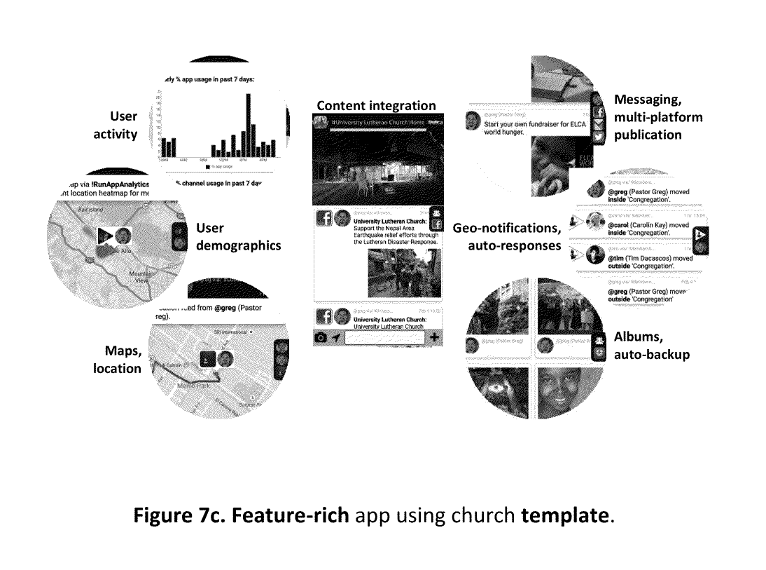

FIGS. 7a shows the process of creating mashup apps from various existing mobile ingredients: apps, devices, and APIs (there are currently around 13,000 APIs listed on programmableweb.com). Places as shown schematically can also come into the mix as some of the mashup features are enabled by or depend on being at a given location. FIG. 7b shows what ingredients can be used in a church app as an example. FIG. 7c shows various features of a mashup app in one embodiment of this.

Flows

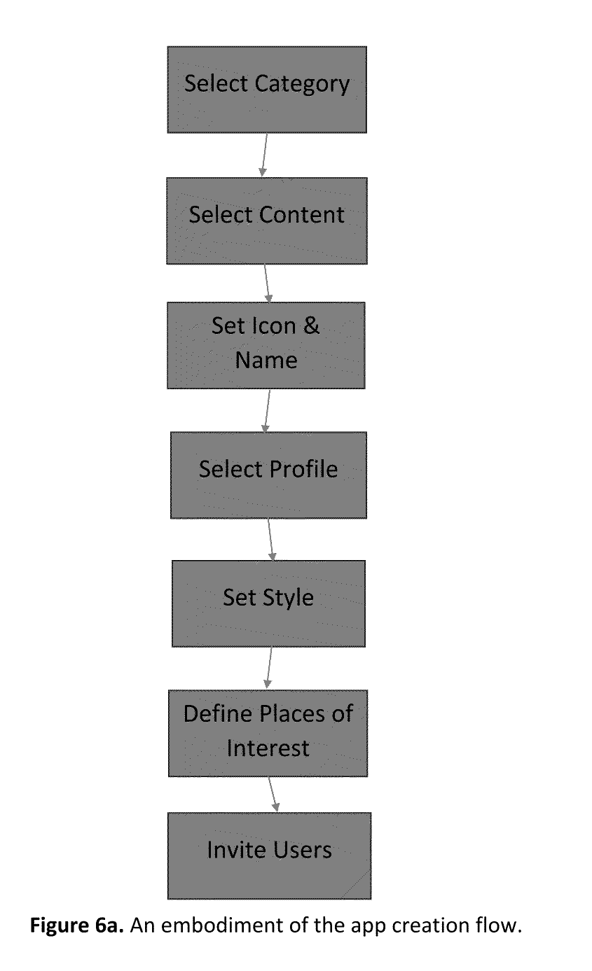

This cloud-based platform provides multiple flows to support a Unity of Apps service for users. Users can register and sign-on to this service (using their email or Facebook, LinkedIn, Twitter, Google, etc. credentials through an OAuth process) and engage these flows to accomplish the following:
Create profiles. This flow allows users to create (edit or delete) a profile representing themselves. Note that this is a one-to-many relationship, and as a result users can participate in apps with different identities. In one embodiment of this, users can pick an alias, provide first name, middle name, and last name, as well as upload an avatar/photo.
Register (third party) apps, and things, and APIs. This flow allows users to securely plug-in their existing apps, things, service APIs, or channels into the platform data hub. Other users will not be able to see or alter any content from these unless the user shares them explicitly as feeds. In one embodiment of this, users are able to register apps through an OAuth process. In another embodiment, users are able to register apps using webhooks so that apps and API services connect to the datahub using REST API endpoints and listeners. Examples include Facebook (e.g., pages, albums, calendar, feeds, etc.), Gmail, Twitter, Fitbit, JawboneUP, Reddit, Philips Hue lamps, Nest, Slack, and various other open API apps and things. Apps created through the platform are already plugged in to the data hub.
Create apps. This flow allows users to create apps in a multistep fashion. In one embodiment of this (FIG. 6) a user achieves this through the following steps:

1. Category. The user selects the app category (restaurant, church, club, etc.). The selected category determines what app template will be used to create the app.

2. Content. The user selects sources of content for the app. This can be a channel from any third party app or thing the user has plugged-in to the data hub, or a channel from any other app created through this platform that the user has access to as a public or private member. A registered Facebook page feed is a typical source of content for an app.

3. Icon & Name. The user sets the app name and uploads an app icon, as well as optionally adds a description for the app.

4. Profile. The user selects or creates the profile he/she wants to be represented as in this app as owner of the app.

5. Style. The user selects the cover photo of the home channel of the app as well as various other style settings such as font and the color palette for the app.

6. Places of Interest. The user defines places of interest for the app. These places can be then used as geofence or filter locations in the app.

7. Invite. The user can invite other users to the app.
Omni-search apps, profiles, and things. This is a typical search and browse flow for everything in the app ecosystem, including public apps and profiles, and the user's private apps and profiles.
Invite and recommend apps. In this flow the user gets to invite and recommend apps to the users.
Publish app to App Store or Google Play. The user can publish the app to the App Store or Google Play.

In addition to the above flows the platform provides app recommendations to users based on the network using machine learning techniques.

Integrations

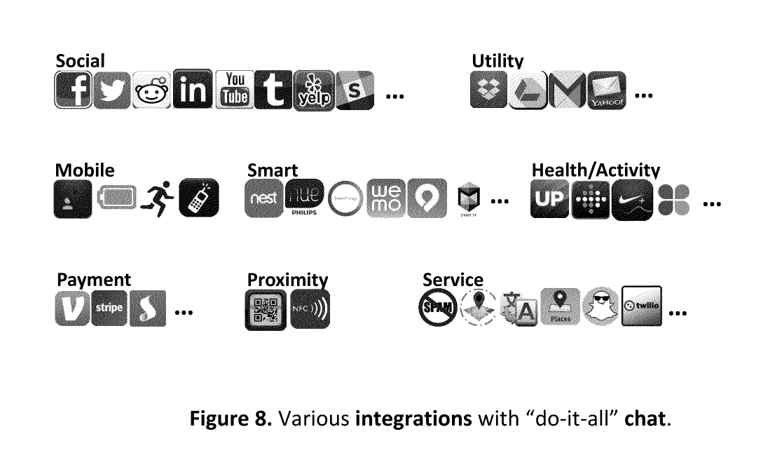

There are many app services, devices, and APIs available today that can be integrated to be used as ingredients in mashup apps or ‘do-it-all’ messaging/chat. This is shown in FIG. 8. Some of the categories are: social (Facebook, Twitter, LinkedIn, . . . ), utility (Dropbox, Google Drive, Gmail, . . . ), mobile device (location, battery level, activity, . . . ), smart home (Nest, Philips Hue, Smart TV, . . . ), health/activity (JawboneUP, Fitbit, Withings, . . . ), payment (Venmo, Stripe, Google Wallet, . . . ), proximity (QR code and NFC tag), and various other services (SpamAssassin, Geofencing, Google translate, Google places, Message snapper, Twilio SMS, . . . ).

These mostly represent channels but others are implemented as a chat bot. For example SpamAssassin becomes a chat bot to block spam or profane messages. Other chat bot examples include: snapchat (deletes messages older than given time), check-in (only allows messages that are sent from a given location), geofencer (notifies the movement of a user w.r.t. a place), user proximity (notifies when a user is near you or reports distance), autoresponder (automatically responds with a message when user sends a post), and geo-notifier (automatically sends a message based on movement of user).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electronic application building system comprising:
a processor;
a computer readable storage media that comprises instructions stored in the computer readable storage media that are executable with the processor, the instructions comprising:
instructions to display a list of application components;
instructions to store information about the selection and configuration of application components in response to a component selection command indicative of a user selecting an application component;
instructions to store information about the selection and configuration of application components in response to a component configuration command indicative of a user configuring an application component.

2. The electronic application building system of claim 1, wherein the computer readable storage media further comprises:
instructions to display a list of application templates;
instructions to store information about selection and configuration of application components based on a selected template in response to a template selection command indicative of a user selecting an application template.

3. The electronic application building system of claim 1, wherein the computer readable storage media further comprises:
instructions to execute and display a selected and configured application as a channel view, where the channel view display is in one of the following formats: album, map, calendar, web, game, survey/quiz.

4. The electronic application building system of claim 1, wherein the application components comprise applications, devices, application programming interface services, or virtual workers.

5. The electronic application building system of claim 1, wherein the computer readable storage media further comprises:
instructions to execute and display the selected and configured application components integrated into a messaging application.

6. An electronic application building system comprising:
a processor;
a computer readable storage media that comprises instructions stored in the computer readable storage media that are executable with the processor, the instructions comprising:
instructions to display a visual representation of a chat or application channel;
instructions to display a user control element capable of adding users to a chat or application channel;
instructions to add a user to a chat or application channel in response to an add command indicative of a user manipulating the user control element in order to add a user;
instructions to display a member control element, visually similar to the user control element, that is capable of adding feed-ins, feed-outs, and virtual workers to a chat or application channel;
instructions to add a feed-in, feed-out, or virtual worker to a chat or application channel in response to an add command indicative of a user manipulating the member control element in order to add a feed-in, feed-out, or virtual worker.

7. A method of electronic application building comprising:
displaying with a display device a visual representation of a chat or application channel;
displaying with a display device a user control element capable of adding users to a chat or application channel;
in response to receipt from an input device of a user add command:
saving to a database a chat or application channel configuration with an additional user added;
displaying with a display device a member control element, visually similar to the user control element, that is capable of adding feed-ins, feed-outs, and virtual workers to a chat or application channel;
in response to receipt from an input device of a member add command:
saving to a database a chat or application channel configuration with an additional feed-in, feed-out, or virtual worker added.
